(19) United States
(12) Patent Application Publication
(10) Pub. No.: US 2007/0267594 A1
(43) Pub. Date: Nov. 22, 2007

(54) Ferrite materials, methods of preparing the same, and products formed therefrom

(76) Inventors: Mark A. Fanton, Cabot, PA (US); Steven W. Spence, Cabot, PA (US); Joseph F. Huth, Butler, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/435,625

(22) Filed: May 17, 2006

(51) Int. Cl. H01F 1/00

(52) U.S. Cl. 252/62.62; 252/62.59

(57) ABSTRACT

Ferrite materials are disclosed, comprising, as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO. Embodiments provided herein also include, as minor components, an amount of calcium component ranging from 0.010 to 0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅. Methods of forming the ferrite materials and products formed therefrom are also disclosed herein. The sintered material may have a power loss of less than 1000 mW/cm³ at a frequency of 500 kHz and a magnetic flux density of at least 4000 G at a temperature of 100° C.

### FIELD

The present disclosure relates to ferrite materials and, more particularly, to manganese-zinc ferrite materials, methods of forming the same, and products made therefrom.

### BACKGROUND

Ferrite materials, such as manganese-zinc ferrite compounds, have been widely used as magnetic core materials for transformers in power supply systems, as well as for household electric appliances, communication and telecommunication equipment, computer and peripheral equipment, electronics finished products, electronic components, and other products that employ high frequency electronic circuitry. Ferrite materials have been found to exhibit properties such as, high permeability, high saturation magnetic flux density, high temperature stability, and low power losses that make these materials suitable for high frequency applications. For example, in transformer applications for power supply systems, sintered ferrite materials provide relatively low power losses and high temperature stability when used at relatively high switching frequencies. Typically, with switching frequencies ranging from 100 kHz to 500 kHz, power losses are measured to be about 300 milliwatts per cubic centimeter (mW/cm³) or greater, and Curie temperatures range from 230° C. to 250° C. These power materials have been engineered to have their losses minimized at temperatures ranging anywhere from 25° C. to 100° C., depending on the application. The temperature of minimum core loss is selected to coincide with the anticipated operating temperature of the power supply. While some commercially available ferrite materials have Curie temperatures advertised to be as high as 300° C., such as 3F5 from Ferroxcube, there are no materials optimized to provide a combination of minimum core loss at temperatures beyond 120° C. and saturation flux densities of 4700 gauss (G) or more. As used herein, Curie temperature refers to the critical temperature at which ferrite materials substantially lose their magnetic characteristics. It is the combined benefits of relatively low power losses and high temperature stability, for example, that make ferrite compositions particularly well suited for various and wide ranging high frequency electrical applications.

Due, in part, to the increased demand for employing high frequency electronic circuitry into a wide range of components and equipment, efforts have been made to advance the ways in which power supplies can be improved and/or miniaturized for integration into these applications. This demand, at times, has been tempered by the premium that is placed on the available space inside these components. Typically, these efforts are directed to improving the ability of the power supply to perform at high temperatures and high frequencies with low core power losses, so that the size can be reduced without sacrificing performance or operation. Thus, much of the attention devoted to the miniaturization process is related to improvements to the material properties of the ferrite materials, and is based on the equation P˜f B A, wherein throughput power (P) is proportional to operating frequency (0, magnetic flux density (B), and magnetic cross section (A). Accordingly, increases in operating frequency and/or magnetic flux density allow for reductions in magnetic cross section without sacrificing throughput power. However, one disadvantage of operating power supplies at higher frequencies relates to a corresponding increase in core power losses that often limit the throughput power and result in an overheating of the core. Another disadvantage is the decrease of usable flux density in the material as the operating temperature is increased. Thus, improving the material properties of ferrite materials should also take into account effects on power losses.

Numerous attempts have been made to improve the chemical formulations of ferrite compositions, or the process conditions in which these compositions are sintered, in order to improve their material properties and allow these materials to operate at higher temperatures and higher frequencies with limited power losses. Some of these attempts are disclosed in U.S. Pat. Nos. 3,415,751, 3,481,876, 3,652,416, 3,769,219, 5,143,638, 5,368,763, 5,518,642, and 5,846,448. These patents disclose the use of various amounts and combinations of Fe₂O₃, MnO, and ZnO as major components, and one or more of Nb₂O₅, CaO, SiO₂, V₂O₅, ZrO₂, Al₂O₃, SnO₂, CuO, Co₃O₄, TiO₂, Co₂O₃, Li₂O, Sb₂O₃, Ta₂O₅, for example, as minor components, at various processing conditions, such as sintering temperatures and pressures, that are said to provide improved properties to the ferrite material. One such objective of these attempts is to enhance the resistivity of the ferrite material by improving the grain boundary resistivity and the resistivity of the ferrite grains themselves. For example, along with the major components, prior art compositions for high frequency applications have included relatively large amounts of Co₃O₄, SnO₂, TiO₂, CaO, and the like, or combinations thereof, as minor components, in order to achieve certain material properties and characteristics.

In particular, a common approach to reduce power losses is to increase the resistivity of the ferrite material in order to reduce eddy current losses at high frequencies. The various auxiliary additives, discussed above, in combination with Fe₂O₃, MnO, and ZnO have been investigated to achieve this objective. For example, one known composition that is said to improve high frequency losses at frequencies up to 5 MHz includes 55-59 mol % Fe₂O₃, 35-42 mol % MnO, and 6 mol % or less of ZnO, with additions of 0.050-0.300 wt % CaO, 0.005-0.050 wt % SiO₂, and 0.010-0.200 wt % of one or more of the following: ZrO₂, Ta₂O₅, MoO₃, In₂O₃, Sb₂O₃, and Bi₂O₃. Grain size of 2-5 μm is preferred in the final sintered body. Compositions outside of these ranges are said to have higher power losses and lower minimum power loss temperatures.

However, it has been found that the prior art materials are difficult to sinter and achieve consistent material properties because of their sensitivity to firing conditions. Thus, there is a continued need to provide ferrite compositions having improved and consistent material properties, such as high temperature stability and low power loss when used at relatively high frequencies, that allow for improvements in the manufacture and performance of high frequency related compounds that incorporate these materials.

### SUMMARY

The present disclosure provides a ferrite material comprising, as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO. With the major components are present minor components, comprising an amount of calcium component ranging from 0.010 to 0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging from up to 0.050 weight percent calculated as ZrO₂, and an amount of tantalum component ranging from up to 0.060 weight percent calculated as Ta₂O₅.

Also provided is a power supply or a core for a transformer that comprises the ferrite material according to the compositions described immediately above.

In another embodiment, a sintered manganese-zinc ferrite material is provided having a Curie temperature of at least 290° C.

In another embodiment, a sintered material is provided that comprises a manganese-zinc ferrite material having a power loss of less than 1000 mW/cm³ at a frequency of 500 kHz and a magnetic flux density of at least 4000 G at a temperature of 100° C.

In yet another embodiment, the present disclosure provides a ferrite material, consisting essentially of, as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO. To the main components may be present, as minor components, an amount of calcium component ranging from 0.010 to 0.0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅.

Also provided is a method of forming a ferrite material that comprises mixing, as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO. To the main components may be mixed minor components that include an amount of calcium component ranging from 0.010 to 0.0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅. The major and minor components may be heat treated to form the ferrite material.

In yet another embodiment, the present disclosure provides a method of forming a core material that comprises mixing, as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO. To the main components may be mixed minor components that include an amount of calcium component ranging from 0.010 to 0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅ to form a blend. The blend may be pressed to a density, and sintered to form the core material.

It should be understood that this invention is not limited to the embodiments disclosed in this Summary, and it is intended to cover modifications that are within the spirit and scope of the invention, as defined by the claims.

### DETAILED DESCRIPTION

It is to be understood that certain descriptions of the present disclosure have been simplified to illustrate only those elements and limitations that are relevant to a clear understanding of the present teaching, while eliminating, for purposes of clarity, other elements. Those of ordinary skill in the art, upon considering the present disclosure, will recognize that other elements and/or limitations may be desirable in order to implement the present teaching. However, because such other elements and/or limitations may be readily ascertained by one of ordinary skill upon considering the present description, and are not necessary for a complete understanding of the present disclosure, a discussion of such elements and limitations is not provided herein. For example, as discussed herein, the materials of the present teaching may be incorporated, for example, as core materials for coils or transformers in various power supplies, and the like. Core materials for coils or transformers are understood by those of ordinary skill in the art, and, accordingly, are not described in detail herein.

Furthermore, compositions of the present teaching will be generally described in the form of a manganese-zinc ferrite material that may be incorporated as high frequency core materials. It will be understood, however, that embodiments set forth in the present disclosure may be embodied in forms and applied to end uses that are not specifically and expressly described herein. For example, one skilled in the art will appreciate that embodiments of the present disclosure may be incorporated into high frequency devices other than core materials that are not specifically identified herein.

The terms “pulverizing,” “pulverized,” and the like, as used herein, refer to mechanically dividing, fragmenting, or disintegrating a material (such as zinc, manganese, and iron oxides or compounds thereof) or other material into a powder. In the embodiments of the present disclosure, pulverization may be carried out in a manner that provides the resultant powder particles with a desired particle size as described herein. As used herein, pulverization includes, for example, all forms of mechanically dividing, fragmenting, or disintegrating a larger mass into a powder, including atomization, crushing, milling, grinding, cold stream processing, and the like.

Other than in the operating examples, or unless otherwise expressly specified, all of the numerical ranges, amounts, values and percentages such as those for amounts of materials, times and temperatures of reaction, ratios of amounts, and others in the following portion of the specification may be read as if prefaced by the word “about” even though the term “about” may not expressly appear with the value, amount, or range. Accordingly, unless indicated to the contrary, the numerical parameters set forth in the present disclosure and claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is identified herein is incorporated by reference herein in its entirety, but is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure is directed, generally, to ferrite materials, and more particularly, to manganese-zinc (“Mn—Zn”) magnetic ferrite materials and methods of forming and employing the same that are designed to operate over a wide range of high frequencies and/or high temperatures with low power losses. It has been found that low power losses at high frequency and high temperature may be obtained from Mn—Zn materials that are a combination of major components and minor components, and which may be processed at particular sintering conditions, as set forth herein. The materials set forth in the present disclosure may include oxides or compounds that convert into oxides upon heating. These materials include components of iron, manganese, and zinc, as major components, and components of silicon, calcium, and, optionally, niobium (i.e. columbium), zirconium, and tantalum, as minor components.

As illustrated in the working examples set forth herein, the Mn—Zn ferrite compositions of the present disclosure may contain oxides of iron, such as Fe₂O₃, manganese, such as MnO, and zinc, such as ZnO, as major components, and combine amounts of oxides of calcium, such as CaO, silicon, such as SiO₂, and, optionally, niobium, such as Nb₂O₅, zirconium, such as ZrO₂, and tantalum, such as Ta₂O₅, as minor components.

The major components may be added such that the iron component may be present in amounts ranging from 51.0 to 59.0 mol % of the final composition, may be present in amounts ranging from 55.0 to 59.0 mol %, and in some embodiments may be present in amounts ranging from 55.0 to 57.0 mol %, calculated as Fe₂O₃. The manganese component may be present in amounts ranging from 38.0 to 47.0 mol % of the final composition, may be present in amounts ranging from 40.0 to 45.0 mol %, and in some embodiment may be present in amounts ranging from 41.0 to 43.0 mol %, calculated as MnO. The zinc component may be present in amounts ranging from 1.0 to 3.0 mol % of the final composition, may be present in amounts ranging from 1.5 to 22.5 mol %, and in some embodiments may be present in amounts ranging from 1.5 to 2.0 mol %, calculated as ZnO.

With the major components may be present small, but effective, amounts of oxides (or carbonates) of calcium, silicon, and, optionally, niobium, zirconium, and tantalum. The calcium component may be present in amounts ranging from 0.010 to 0.060 wt %, based on the total weight of the ferrite material, may be present in amounts ranging from 0.020 to 0.050 wt %, and in some embodiments may be present in amounts ranging from 0.030 to 0.045 wt %, calculated as CaO. The silicon component may be present in amounts ranging from 0.005 to 0.040 wt %, based on the total weight of the ferrite material, may be present in amounts ranging from 0.010 to 0.030 wt %, and in some embodiments may be present in amounts ranging from 0.015 to 0.025 wt %, calculated as SiO₂. The niobium component may be present with the major components in amounts ranging up to 0.040 wt %, may be present in amounts ranging from 0.010 to 0.030 wt %, and in some embodiments may be present in amounts ranging from 0.015 to 0.025 wt %, based on the total weight of the ferrite material, calculated as Nb₂O₅. The zirconium component may be present with the major components in amounts ranging up to 0.050 wt %, may be present in amounts ranging from 0.020 to 0.050 wt %, and in some embodiments may be present in amounts ranging from 0.035 to 0.040 wt %, based on the total weight of the ferrite material, calculated as ZrO₂. The tantalum component may be present with the major components in amounts ranging up to 0.060 wt %, may be present in amounts ranging up to 0.020 wt %, and in some embodiments may be present in amounts ranging from 0.005 to 0.015 wt %, based on the total weight of the ferrite material, calculated as Ta₂O₅.

It will be appreciated by one of ordinary skill in the art that although specific oxides for each metal component are discussed herein, other suitable oxides (or carbonates) of iron, manganese, zinc, silicon, calcium, niobium, zirconium, and tantalum, if applicable, may be used to form the ferrite materials set forth in the present disclosure. Accordingly, although the particular metal oxides disclosed herein (ZnO, MnO, Fe₂O₃, CaO, SiO₂, Nb₂O₅, ZrO₂, and Ta₂O₅) have been found to provide good results in certain embodiments, one of skill in the art would understand that the present embodiments need not be limited to the use of the specific oxidation state identified, and that other metal oxides of other oxidation states or their carbonates may be employed as a partial or complete substitute for the particular metal oxide set forth herein. For example, with respect to iron oxide, embodiments set forth herein may employ FeO, Fe₂O₃, and Fe₃O₄, and compounds capable of being converted into Fe₂O₃, such as iron hydroxide, iron oxalate, and the like; with respect to manganese oxide, embodiments of the present disclosure may employ MnO, MnO₂, Mn₃O₄, and compounds capable of being converted into MnO, such as manganese carbonate, manganese oxalate, and the like; with respect to zinc oxide, the embodiments of the present disclosure may employ ZnO, and compounds capable of converting into ZnO, such as zinc carbonate, zinc oxalate, and the like. Accordingly, although specific metal oxides are reported to describe the components set forth in the present disclosure, one of ordinary skill in the art will understand that the scope of the present disclosure need not be limited to only these specific components.

The ferrite materials of the present disclosure and the products that incorporate the same may be formed by mixing oxides or carbonates of iron, manganese, and zinc as starting materials in the amounts discussed above. Raw materials of iron, manganese, and zinc oxides or carbonates may be mixed before or after pulverization in any manner known to those of ordinary skill in the art, such as through dry blending. The raw materials may be pulverized, such as through grinding, for a time sufficient to achieve an average particle size of the raw materials of 0.9 to 1.9 μm. The raw materials often show variations in the contents of the desired components, which must be monitored and adjusted, if necessary, to the appropriate mole or weight percentage discussed above, because the sintering behavior and resultant material properties are affected by the amounts of these components.

Oxides or carbonates of calcium, silicon, niobium, zirconium, and tantalum may be present, such as by adding, at the start of, during, or following formation of the dry blend of raw materials in the amounts discussed above. Because relatively small amounts of each of the minor components may be employed, in certain embodiments, these components may be added in pure (i.e. at least 99.9%) powder oxide form, rather than in the raw bulk form that may be used to form the blend of major components.

A dispersant, such as Lomar®, commercially available from Henkel Corporation, Morristown, N.J., may be added at the start of, during, or following formation of the dry blend along with other constituents, such as water, to form a slurry. Other dispersants known to those skilled in the art may be employed as long as the dispersant employed is relatively pure and the amount of trace impurities that may be added to the ferrite system is limited. When a dispersant is employed, the specific dispersant to raw component ratio can vary widely so long as it provides the requisite or desired viscosity for pulverizing, with amounts typically ranging from 0.8 wt % to 1.2 wt %, such as 1.0 wt %.

Additives such as polyvinyl alcohol and glycerin may be added to the slurry composition prior to milling that act as sacrificial binder materials for the pressed form. Other binder materials known to those skilled in the art may be employed as long as the binding agent chosen satisfies the relatively strict purity standards that limit the amount of trace impurities in the ferrite system. The amount of binder material that may be added to the system can vary widely. When polyvinyl alcohol and glycerin are employed, each binder material may be added in amounts ranging from 1.0 to 2.0 wt %, such as, for example, 1.5 wt %.

The slurry may be milled and spray dried to produce a granulated powder for pressing into core shapes having a predetermined shape, size, and pressed density. In one embodiment employing a milling process, milling may occur for 15 to 120 minutes. Pressed shapes include, for example, toroids, planar E-cores, and pot cores. The density of the pressed shapes may range from 3.1 to 3.3 g/cm³. For example, where the test cores are pressed into the shapes of toroids, each toroid may have an outside diameter of 22 mm, an inside diameter of 13.7 mm, a height of 6.3 mm, and a density of 3.2 g/cm³. The cores may be sintered at temperatures ranging from 1130° C. to 1200° C., such as 1160° C., and then cooled to temperatures ranging from 20° C. to 30° C. to form the sintered core material. The mean grain size of the resultant sintered core material may range from 4 to 8 μm. The oxygen content of the atmosphere may be controlled during the soak and cooling portions of the cycle based on the temperature and rate of cooling, as known to those of ordinary skill in the art.

As illustrated in the Example and Tables 1-3, it has been found that the Mn—Zn ferrite materials that combine components of iron, such as Fe₂O₃, manganese, such as Mn₃O₄ and zinc, such as ZnO, as major components, and components of silicon, such as SiO₂, calcium, such as CaCO₃, and, optionally, niobium, such as Nb₂O₅, zirconium, such as ZrO₂, and tantalum, such as Ta₂O₅, as minor components, in the amounts discussed above, provide improved properties relative to known ferrite materials. In particular, the compositions of the present teaching have relatively low ZnO content and a high Fe₂O₃ content compared to typical Mn—Zn ferrites, and further combines amounts of CaO, SiO₂, and, optionally, Nb₂O₅ to control and limit power losses. Amounts of ZrO₂ and Ta₂O₅ may be added to control excessive grain growth during the sintering operation. It has been found that embodiments that include the combination of these components provide a material having improved ferrite properties.

Certain embodiments will be described further by reference to the following examples. The following examples are merely illustrative and are not intended to be limiting. Unless otherwise indicated, all parts are by weight.

### EXAMPLES

Raw materials of Fe, Mn, and Zn oxides were dry blended and ground for 1.5 hours in an attrition mill to an average particle size of approximately 1.40 μm. An addition of 1.0 weight percent Lomar® (Henkel Corporation) was added at the beginning of the grinding operation to act as a dispersant. Oxides or carbonates of Ca, Si, and, where applicable, Nb, Zr and Ta, in amounts as set forth in Table 1 below, were also added at the beginning of the grinding operation. Before the resulting slurry was removed from the mill, 1.5 weight percent polyvinyl alcohol and 1.5 weight percent glycerin were added to the slurry. The slurry was milled for another 15 minutes and then spray dried to produce a granulated powder for pressing.

Test cores were pressed in the shape of toroids having an outside diameter of 22 mm, an inside diameter of 13.7 mm and a height of 6.3 mm.

The pressed density of the cores was 3.20 g/cm³. The test cores were sintered at 1160° C. to 1200° C. for 5 hours. The oxygen content of the atmosphere was controlled during the soak and cooling portions of the cycle to control grain growth and grain size distribution.

Compositions of the present disclosure are listed below in Table 1. For comparison, compositions outside the range of the present teaching are shown in Table 2.

TABLE 1
Embodiments of the Present Teaching

| | | MnO | | | | | | |
|---|---|---|---|---|---|---|---|---|
| Lot | Fe₂O₃ | Mol | ZnO | CaO | SiO₂ | Nb₂O₅ | ZrO₂ | Ta₂O₅ |
| No. | Mol % | % | Mol % | Wt % | Wt % | Wt % | Wt % | Wt % |
| 1 | 59 | 39 | 2 | 0.04 | 0.02 | 0.025 | — | — |
| 2 | 58 | 40 | 2 | 0.04 | 0.02 | 0.025 | — | — |
| 3 | 57 | 41 | 2 | 0.04 | 0.02 | 0.025 | — | — |
| 4 | 56.3 | 42 | 1.7 | 0.04 | 0.02 | 0.025 | — | — |
| 5 | 59 | 38 | 3 | 0.04 | 0.02 | 0.025 | — | — |
| 6 | 53 | 44.5 | 2.5 | 0.04 | 0.02 | 0.025 | — | — |
| 7 | 57 | 41.5 | 1.5 | 0.04 | 0.02 | 0.025 | — | — |
| 8 | 55 | 43 | 2 | 0.04 | 0.02 | 0.025 | — | — |
| 9 | 51 | 47 | 2 | 0.04 | 0.02 | 0.025 | — | — |
| 10 | 59 | 40 | 1 | 0.04 | 0.02 | 0.025 | — | — |
| 11 | 56.3 | 42 | 1.7 | 0.06 | 0.015 | 0.025 | — | — |
| 12 | 56.3 | 42 | 1.7 | 0.04 | 0.02 | 0.025 | — | — |
| 13 | 56.3 | 42 | 1.7 | 0.02 | 0.01 | 0.025 | — | — |
| 14 | 57 | 41 | 2 | 0.04 | 0.02 | 0.025 | — | — |
| 15 | 56 | 42 | 2 | 0.04 | 0.02 | 0.025 | — | — |
| 16 | 57 | 40.5 | 2.5 | 0.04 | 0.02 | 0.025 | — | — |
| 17 | 55 | 42.5 | 2.5 | 0.04 | 0.02 | 0.025 | — | — |
| 18 | 56 | 42 | 2 | 0.04 | 0.02 | 0.025 | — | — |
| 19 | 55 | 43.5 | 1.5 | 0.04 | 0.02 | 0.025 | — | — |
| 20 | 56 | 42 | 2 | 0.04 | 0.02 | 0.025 | — | — |
| 21 | 56 | 41.5 | 2.5 | 0.04 | 0.02 | 0.025 | — | — |
| 22 | 56 | 42 | 2 | 0.035 | 0.02 | 0.02 | — | — |
| 23 | 56 | 42 | 2 | 0.06 | 0.01 | 0 | — | — |
| 24 | 56 | 42 | 2 | 0.06 | 0.03 | 0 | — | — |
| 25 | 56 | 42 | 2 | 0.06 | 0.03 | 0.03 | — | — |
| 26 | 56 | 42 | 2 | 0.06 | 0.01 | 0.03 | — | — |
| 27 | 56 | 42 | 2 | 0.01 | 0.01 | 0 | — | — |
| 28 | 56 | 42 | 2 | 0.01 | 0.03 | 0 | — | — |
| 29 | 56 | 42 | 2 | 0.01 | 0.03 | 0.03 | — | — |
| 30 | 56 | 42 | 2 | 0.01 | 0.01 | 0.03 | — | — |
| 31 | 56 | 42 | 2 | 0.035 | 0.02 | 0.02 | 0.01 | 0.01 |
| 32 | 56 | 42 | 2 | 0.035 | 0.02 | 0.02 | 0.01 | 0.05 |
| 33 | 56 | 42 | 2 | 0.035 | 0.02 | 0.02 | 0.025 | 0.03 |
| 34 | 56 | 42 | 2 | 0.035 | 0.02 | 0.02 | 0.04 | 0.01 |
| 35 | 56 | 42 | 2 | 0.035 | 0.02 | 0.02 | 0.04 | 0.05 |
| 36 | 56 | 42 | 2 | 0.035 | 0.02 | 0.02 | — | — |
| 37 | 56 | 42 | 2 | 0.035 | 0.02 | 0.02 | — | — |

TABLE 2
Comparative Examples of Compositions Outside Range of
Present Teaching

| | | | ZnO | | | | | |
|---|---|---|---|---|---|---|---|---|
| Lot | Fe₂O₃ | MnO | Mol | CaO | SiO₂ | Nb₂O₅ | ZrO₂ | Ta₂O₅ |
| No. | Mol % | Mol % | % | Wt % | Wt % | Wt % | Wt % | Wt % |
| 38 | 55.7 | 44.3 | 0* | 0.035 | 0.02 | 0.02 | 0.04 | 0.01 |
| 39 | 55.55 | 43.95 | 0* | 0.035 | 0.02 | 0.02 | 0.04 | 0.01 |
| 40 | 57 | 43 | 0* | 0.035 | 0.02 | 0.02 | 0.04 | 0.01 |
| 41 | 59 | 41 | 0* | 0.035 | 0.02 | 0.02 | 0.04 | 0.01 |
| 42 | 57 | 42.5 | 0.5* | 0.035 | 0.02 | 0.02 | 0.04 | 0.01 |
| 43 | 55 | 44.75 | 0.25* | 0.035 | 0.02 | 0.02 | 0.04 | 0.01 |
| 44 | 58 | 41.75 | 0.25* | 0.035 | 0.02 | 0.02 | 0.04 | 0.01 |
| 45 | 55.91 | 42.94 | 1.15* | 0.035 | 0.02 | 0.02 | 0.04 | 0.01 |
| 46 | 57.09 | 41.99 | 0.92* | 0.035 | 0.02 | 0.02 | 0.04 | 0.01 |
| 47 | 59.39* | 38.59* | 2.02 | 0.035 | 0.02 | 0.02 | 0.04 | 0.01 |
| 48 | 59.40* | 37.08* | 3.52* | 0.035 | 0.02 | 0.02 | 0.04 | 0.01 |
| 49 | 55.84 | 40.15 | 4.01* | 0.035 | 0.02 | 0.02 | 0.04 | 0.01 |
| 51 | 50.38* | 47.64 | 1.98 | 0.035 | 0.02 | 0.02 | 0.04 | 0.01 |

*values outside of composition range of embodiments of the present teaching

TABLE 3
Electrical Properties

| | | | | | | Min. | | |
|---|---|---|---|---|---|---|---|---|
| | | Bmax | Bmax | Bmax | | Watt | Watt Loss | |
| | Perm | 15 Oe. | 15 Oe. | 15 Oe. | Location of | Loss | 500 kHz, | |
| Lot | 100 kHz | 25° C. | 200° C. | 300° C. | SMP | Temp. | 500 G | Curie |
| No. | 25° C. | (kG) | (kG) | (kG) | (° C.) | (° C.) | mW/cc | Temp. (° C.) |
| 1 | 470 | 5425 | | | −40 | | | |
| 2 | 680 | 5325 | | | −15 | | | |
| 3 | 1035 | 5350 | | | 0 | | | |
| 4 | 660 | 5000 | 3320 | | 145 | 160 | 149 | 330 |
| 5 | 500 | | | | −30 | | | |
| 6 | 650 | | | | 230 | | | 280 |
| 7 | 610 | | | | 130 | | | |
| 8 | 770 | | | | 220 | | | 320 |
| 9 | 410 | | | | 230 | | | 270 |
| 10 | 870 | | | | 40 | | | 330 |
| 11 | 650 | | | | 145 | 160 | 175 | 330 |
| 12 | 620 | | | | 145 | 160 | 240 | 330 |
| 13 | 660 | | | | 145 | 160 | 540 | 330 |
| 14 | 620 | 5110 | | | 135 | 140 | 122 | 330 |
| 15 | 500 | 5000 | | | 135 | 140 | 122 | 330 |
| 16 | 660 | 5115 | | | 130 | 140 | 108 | 330 |
| 17 | 420 | 4850 | | | 220 | | | 300 |
| 18 | 495 | 5020 | | | 190 | | | 320 |
| 19 | 300 | 4675 | | | 230 | | | 300 |
| 20 | 485 | 5012 | 3200 | 1460 | 195 | 180 | 194 | 320 |
| 21 | 565 | 5045 | | | 180 | | | 320 |
| 22 | 520 | 4930 | 3136 | 1205 | 160 | 160 | 122 | 320 |
| 23 | 480 | 4860 | 3088 | 1137 | 160 | 150 | 235 | 320 |
| 24 | 520 | 4990 | 3208 | 1268 | 175 | 160 | 290 | 320 |
| 25 | 285 | 4960 | 3265 | 1181 | 175 | 160 | 970 | 320 |
| 26 | 620 | 4910 | 3118 | 1140 | 170 | 180 | 100 | 320 |
| 27 | 455 | 4800 | 3079 | 1178 | 160 | 160 | 820 | 320 |
| 28 | 480 | 4970 | 3198 | 1216 | 170 | 160 | 730 | 320 |
| 29 | 335 | 5070 | 3308 | 1277 | 180 | 160 | 800 | 320 |
| 30 | 490 | 4847 | 3100 | 1179 | 160 | 160 | 295 | 320 |
| 31 | 600 | 4823 | 3054 | 1124 | 180 | 165 | 95 | 320 |
| 32 | 720 | 4850 | 3170 | 1410 | 160 | 200 | 100 | 320 |
| 33 | 710 | 4850 | 3180 | 1430 | 160 | 200 | 98 | 320 |
| 34 | 700 | 4750 | 3080 | 1320 | 160 | 200 | 90 | 320 |
| 35 | 700 | 4870 | 3180 | 1460 | 150 | 200 | 110 | 320 |
| 36 | 510 | 4675 | 2915 | 759 | 200 | 200 | 154 | 320 |
| 37 | 640 | 4725 | 3001 | 1127 | 175 | 180 | 150 | 320 |
| 38 | 352* | | | | 210 | 180 | 164* | |
| 39 | 186* | | | | 215 | 200 | 359* | |
| 40 | 397* | | | | 150 | 160* | 141* | |
| 41 | 249* | | | | 65 | 60* | 938* | |
| 42 | 416* | | | | 135 | 120* | 133* | |
| 43 | 333* | | | | 220 | 200 | 136* | |
| 44 | 351* | | | | 80 | 60* | 389* | |
| 45 | 526 | | | | 210 | 200 | 129* | |
| 46 | 550 | | | | 130 | 150* | 82 | |
| 47 | 601 | | | | 60 | 60* | 176* | |
| 48 | 682 | | | | 50 | 60* | 84 | |
| 49 | 748 | | | | 135 | 160* | 90 | |
| 50 | 264* | | | | 220 | 220 | 511* | |

*Degraded properties of comparative examples relative to embodiments of the present teaching.
Empty cells indicate no test was performed

As shown in the Examples, in corresponding Tables 1, 2 and 3, and as discussed herein, the ferrite materials of the present teaching combine components of iron, such as Fe₂O₃, manganese, such as MnO, and zinc, such as ZnO, as major components, and components of silicon, such as SiO₂, calcium, such as CaO, and, optionally, niobium, such as Nb₂O₅, zirconium, such as ZrO₂, and tantalum, such as Ta₂O₅ as minor components, in specified amounts, to provide improved properties relative to known ferrite materials. In Table 2, compositions 38 through 50 show core properties are degraded when compared to cores made according to embodiments of the present teaching. Most notably, cores made from compositions outside of the ranges set forth herein exhibit higher core loss, lower permeability, and/or minimum waft loss temperature values less than 180° C.

Compositions as described in the present disclosure control and limit power losses and result in a material having a low permeability and a high Curie temperature. The materials as set forth in the present disclosure can limit, or substantially eliminate, the addition of large amounts of Co₃O₄, SnO₂, TiO₂, CaO, and the like, or combinations of these components, while achieving exceptionally good material properties. Accordingly, sintering the combination of major and minor components provides ferrite materials having more consistent material properties relative to known compositions because of their lesser degree of sensitivity to firing conditions.

It has been found that embodiments as described herein provide a ferrite material having a low zinc content (3.0 percent by weight or less) and high iron content relative to typical MnZn ferrites that results in a material with improved properties. For example embodiments of the present teaching exhibit a permeability (μ) ranging from 300 to 1600 and more typically ranging from 700 to 800 at 25° C. In addition, it has been found that certain embodiments of the present teaching provide a ferrite material with a Curie temperature of greater than 270° C., may be 290° C. or greater, in some embodiments 300° C. or greater, and in other embodiments 310° C. or greater.

The relatively high Curie temperatures obtained in certain embodiments of the present teaching also improve the flux density versus temperature response of the material allowing it to be used simultaneously at higher flux densities and higher temperatures. Measurements taken of certain embodiments of the present disclosure indicate maximum magnetic flux densities (Bₘₐₓ) of at least 4000 G, and in some embodiments at least 4200 G, at 100° C. are readily attainable. Test results also indicate that a Bₘₐₓ of at least 3000 G are exhibited. At 300° C., Bₘₐₓ of at least 1000 G, and in some embodiments at least 1300 G, are exhibited. These measurements are significantly higher than known Mn—Zn ferrite materials designed for high frequency applications where a Bₘₐₓ of less than 3500 G at 100° C., and about 1000 G at 200° C. are disclosed.

Power losses of sintered compositions of the present teaching were measured by winding the toroid test samples with the appropriate number of turns of wire and then applying a sine wave voltage at the desired frequency and at an amplitude sufficient to generate the desired flux density in the core. The current (I) required to achieve the set voltage (V) was then measured, as was the phase angle (θ) between the applied voltage and the measured current. Power losses are expressed as: P=VI cos θ. The power in watts is divided by the volume of the test specimen to obtain a normalized power loss in milliwatts per cubic centimeter of material (mW/cm³). This loss measurement includes losses due to the copper windings, which were assumed to be small.

As further illustrated, at the minimum watt loss temperatures listed in Table 3, embodiments of the present teaching limit, or substantially reduce, the power loss at frequencies of 500 kHz at 500 G relative to known ferrite materials. Measurements of embodiments of the present teaching indicate that power losses may be less than 1000 mW/cm³, may be less than 300 mW/cm³, and in some embodiments are less than 100 mW/cm³ at frequencies of 500 KHz at 500 G.

It has been found that the temperature at which the minimum watt loss occurs can be tailored by careful selection of the appropriate composition of Fe₂O₃ and ZnO and the careful control of the oxygen content of the sintering atmosphere. Minimum loss temperatures between −30° C. and 250° C. have been observed while simultaneously maintaining the Curie temperature above 270° C. Additions of trace, but effective, amounts of CaO, SiO₂, and Nb₂O₅ work together to control power losses.

It has been found that certain embodiments of the present teaching have been successful at simultaneously achieving low power losses at frequencies up to 500 kHz, minimum power loss at a temperature of 100° C. or greater, saturation magnetic flux density greater than 4000 G at 100° C., a Curie temperature greater than 270° C., while providing relative ease of processing. Prior art techniques have not been successful in meeting this combination of the performance criteria. Embodiments of the present teaching meet these requirements and also provide a much simpler composition than other compositions found in the prior art. The end result is a magnetic material with superior performance that is simple and efficient to process.

Compositions as set forth in the present disclosure use the combination of the oxides (or carbonates) described herein, particularly those compositions that employ Nb₂O₅, ZrO₂, and Ta₂O₅ and relatively low amounts of CaO, result in ferrite materials having improved chemical and physical properties, as illustrated in the Examples and Tables 1-3. Accordingly, improvements to the magnetic flux density, and power loss at high operating frequencies up to 500 kHz allow reduction in the magnetic cross section of the core materials that employ the compositions of the present teaching.

Test results of the materials of the present teaching show that there is another composition region in which Bₘₐₓ can be increased to near or above 5000 G at 25° C. and increased above 4000 G at 100° C. It has also been found that relative to the materials of the present teaching, prior art materials do not achieve the same level of performance and are more difficult to process. The present teaching demonstrates that fewer additive additions at much lower concentrations are more effective at reducing power losses even though the resistivity of the material may not be increased.

The compositions of the present teaching are unique in that they contain much higher levels of MnFe₂O₄ and FeFe₂O₄ than conventional MnZn ferrite materials. Although not intending to be bound by any theory, it is believed that the higher concentrations of these two species in embodiments of the present teaching play, at least, some role in a higher Curie temperature exhibited.

It should be noted that although certain embodiments as set forth in the present disclosure and identified in the Examples are identified as only having components of iron, such as Fe₂O₃, manganese, such as MnO, and zinc, such as ZnO, as major components, and components of silicon, such as SiO₂, calcium, such as CaO, and, optionally, niobium, such as Nb₂O₅, zirconium, such as ZrO₂, and tantalum, such as Ta₂O₅ as minor components, it is contemplated that the Mn—Zn ferrite materials as provided herein may include these components, ranging in amounts described herein, as well as other minor components know to those skilled in the art that impart desirable properties to the material.

It will be appreciated by those of ordinary skill in the art that the improved properties of the materials as disclosed herein allow these materials to be incorporated into products that require high frequency operation, such as those related to commercial switching power supplies, as well as for household electric appliances, communication and telecommunication equipment, computer and peripheral equipment, electronics finished products, electronic components, down hole oil drilling sensors, automotive applications, and other high frequency electronic circuitry. Certain embodiments of the present teaching provide for high temperature operation of 100° C. or higher, with low power losses at high flux densities and high frequencies that provide increased power performance to be added to products having a limited area, that may allow for miniaturization of the core volume.

It will also be appreciated by those skilled in the art that changes could be made to the embodiments described herein without departing from the broad inventive concept thereof. It is understood, therefore, that this invention is not limited to the particular embodiments disclosed, but it is intended to cover modifications that are within the spirit and scope of the invention, as defined by the claims.

1. A ferrite material, comprising:
as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO; and
as minor components, an amount of calcium component ranging from 0.010 to 0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging from up to 0.050 weight percent calculated as ZrO₂, and an amount of tantalum component ranging from up to 0.060 weight percent calculated as Ta₂O₅.

2. The ferrite material according to claim 1, wherein the amount of iron component ranges from 55.0 to 59.0 mole percent.

3. The ferrite material according to claim 2, wherein the amount of iron component ranges from 55.0 to 57.0 mole percent.

4. The ferrite material according to claim 1, wherein the amount of manganese component ranges from 40.0 to 45.0 mole percent.

5. The ferrite material according to claim 4, wherein the amount of manganese component ranges from 41.0 to 43.0 mole percent.

6. The ferrite material according to claim 1, wherein the amount of zinc component ranges from 1.5 to 2.5 mole percent.

7. The ferrite material according to claim 6, wherein the amount of zinc component ranges from 1.5 to 2.0 mole percent.

8. The ferrite material according to claim 1, wherein the amount of calcium component ranges from 0.020 to 0.050 weight percent.

9. The ferrite material according to claim 8, wherein the amount of calcium component ranges from 0.030 to 0.045 weight percent.

10. The ferrite material according to claim 1, wherein the amount of silicon component ranges from 0.010 to 0.030 weight percent.

11. The ferrite material according to claim 10, wherein the amount of silicon component ranges from 0.015 to 0.025 weight percent.

12. The ferrite material according to claim 1, wherein the amount of niobium component ranges from 0.010 to 0.030 weight percent.

13. The ferrite material according to claim 12, wherein the amount of niobium component ranges from 0.015 to 0.025 weight percent.

14. The ferrite material according to claim 1, wherein the amount of zirconium component ranges from 0.020 to 0.050 weight percent.

15. The ferrite material according to claim 14, wherein the amount of zirconium component ranges from 0.035 to 0.040 weight percent.

16. The ferrite material according to claim 1, wherein the amount of tantalum component ranges up to 0.020 weight percent.

17. The ferrite material according to claim 16, wherein the amount of tantalum component ranges 0.005 to 0.015 weight percent.

18. The ferrite material according to claim 1, wherein the material has been pulverized to an average particle size of 0.9 to 1.9 μm.

19. A sintered material comprised of the ferrite material according to claim 1, and having a Curie temperature of at least 270° C.

20. The sintered material of claim 19, wherein the ferrite material has a Curie temperature of at least 290° C.

21. The sintered material of claim 19, wherein the ferrite material has a Curie temperature of at least 300° C.

22. The sintered material of claim 19, wherein the ferrite material has a Curie temperature of at least 310° C.

23. A sintered material comprised of a manganese-zinc ferrite material having a power loss of less than 1000 mW/cm³ at a frequency of 500 kHz and a magnetic flux density of at least 4000 G at a temperature of 100° C.

24. The sintered material of claim 23, wherein the power loss is less than 300 mW/cm³.

25. The sintered material of claim 24, wherein the power loss is less than 100 mW/cm³.

26. The sintered material of claim 23, wherein the magnetic flux density is at least 4200 G at a temperature of 100° C.

27. A core for a transformer comprised of the ferrite material of claim 1.

28. A power supply comprising a converter having a core for a transformer comprised of the ferrite material of claim 1.

29. A sintered manganese-zinc ferrite material having a Curie temperature of at least 290° C.

30. The sintered material of claim 29, wherein the ferrite material has a Curie temperature of at least 300° C.

31. The sintered material of claim 29, wherein the ferrite material has a Curie temperature of at least 310° C.

32. A ferrite material, consisting essentially of:
as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO; and
as minor components, an amount of calcium component ranging from 0.010 to 0.0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅.

33. A method of forming a ferrite material, comprising:
mixing as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO;
mixing with the main components minor components, an amount of calcium component ranging from 0.010 to 0.0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅; and
heat treating the major and minor components to form the ferrite material.

34. The method of claim 33, wherein the major and minor components have been pulverized to an average particle size of 0.9 to 1.9 μm.

35. The method of claim 34, further comprising drying the major and minor components to form a pressable powder

36. A method of forming a core material, comprising:
mixing as main components, an amount of iron component ranging from 51.0 to 59.0 mole percent calculated as Fe₂O₃, an amount of manganese component ranging from 38.0 to 47.0 mole percent calculated as MnO, and an amount of zinc component ranging from 1.0 to 3.0 mole percent calculated as ZnO; and
mixing with the main components minor components comprising an amount of calcium component ranging from 0.010 to 0.060 weight percent calculated as CaO, an amount of silicon component ranging from 0.005 to 0.040 weight percent calculated as SiO₂, and, optionally, an amount of niobium component ranging up to 0.040 weight percent calculated as Nb₂O₅, an amount of zirconium component ranging up to 0.050 weight percent calculated as ZrO₂, and an amount of tantalum component ranging up to 0.060 weight percent calculated as Ta₂O₅ to form a blend;
pressing the blend to a density; and
sintering the blend to form the core material.

37. The method of claim 36, wherein the major and minor components are pulverized to an average particle size of 0.9 to 1.9 μm.
